(19) United States
(12) Patent Application Publication
(10) Pub. No.: US 2011/0280985 A1
(43) Pub. Date: Nov. 17, 2011

(54) Ejector retraction mechanism

(76) Inventors: Adelino C. Santos, West Hartford, CT (US); Eric Paul Kaufman, Farmington, CT (US)

(21) Appl. No.: 12/803,300

(22) Filed: May 17, 2010

(51) Int. Cl. B29C 45/40

(52) U.S. Cl. 425/556

(57) ABSTRACT

An improved ejector retraction mechanism comprises a fixed actuator, a pair of blocking members positively movable both in and out of the path of the actuator, whereby to positively retract ejector pins on closing of the molds. The actuator and blocking members have flat parallel engaging surfaces for long wear and durability and the actuator also has an enlarged portion which enters a channel and aligns and interlocks the molds.

### BACKGROUND OF THE INVENTION

This invention relates in general to molding apparatus and deals more particularly with an improved ejection retraction mechanism which positively controls the movement of an ejector mechanism toward both open and closed positions, locks in the closed position, and which also precisely aligns the mold cavities on closing of the molds.

In an apparatus for the manufacturing of molded products, an ejector mechanism is usually provided to assure positive removal of finished work pieces from the mold cavities during the mold opening cycle. Such ejector mechanisms usually employ one or more ejector pins movable into a mold cavity associated with one of the molds during the opening cycle. An ejector retraction mechanism operates to retract the ejector pins from the mold cavity section during the closing cycle and before the molds are fully closed to prevent damage to the ejector pins or the mold cavity. More sophisticated molding apparatus for the production of hollow molded products usually requires one or more core elements arranged to move with and relative to one of the mold cavity plates transversely into and out of the mold cavity defined by the plates during the operational cycle of the apparatus. More specifically, the core element or elements are generally arranged to move transversely into molding position during the mold closing cycle and to retract during the opening cycle. Thus, an ejector retraction mechanism for such molding apparatus must operate in properly timed relation with the cycle of the molds to permit the ejector mechanism to operate during the opening cycle and to assure positive retraction of the ejector mechanism during the closing cycle to prevent risk of damage to either the ejector mechanism or the core element which may move transversely into the path of travel of the ejector mechanism pins. The aforedescribed problem is discussed in some detail in U.S. Pat. No. 3,516,302 to Muttart issued Jun. 23, 1970 and in U.S. Pat. No. 4,082,345 to Santos [an inventor in the present application] issued Apr. 4, 1978. The present invention is concerned with an improved ejector retraction mechanism of the afore-described type.

It is the general object of the present invention to provide an improved ejector retraction mechanism of simple durable construction for low cost manufacture and simple installation and which may be mounted on a molding apparatus without reducing the effective usable area of mold plates.

A further object of the invention is to provide such an ejector retraction mechanism, which has a dual function, i.e., also to precisely align and interlock the molds or mold plates.

A still further object of the invention is to provide an improved and highly efficient blocking and actuator system of improved structural integrity over long use.

A still further object of the invention is to provide an improved and highly efficient blocking and actuator system, which provides for both positive opening and closing of actuator blocking members.

### SUMMARY OF THE INVENTION

In accordance with the present invention, an improved ejector retraction mechanism is provided for a molding apparatus having molds or mold plates movable between open and closed positions and an ejector mechanism movable with, and relative to, one of the mold plates. The retraction mechanism comprises an actuating member or actuator mounted in fixed position relative to one of the mold cavity plates, at least one actuator blocking member, and means supporting the blocking member for positive movement both with and relative to the ejector mechanism between a first closed position wherein the blocking member is in the path of the actuating member and a second open position wherein the blocking member is retracted from the path of the actuator. Means for pivoting the blocking member from its closed to its open position operates in response to movement of the ejector mechanism toward its ejection position, the actuator being engageable with the blocking member in its closed position to retract the ejector mechanism in response to movement of the molds toward each other.

### BRIEF DESCRIPTION OF THE DRAWINGS

FIG. 1 is a fragmentary side elevational view of a molding apparatus having an ejector retraction mechanism embodying the present invention and shown partially in section.

FIG. 2-5 are similar to FIG. 1 and illustrate the operating sequence of the apparatus of FIG. 1.

FIG. 6 is a somewhat enlarged fragmentary sectional view taken along the line 6-6 of FIG. 5.

FIG. 7 is a fragmentary side elevational view of a mold base having an ejector retracting mechanism illustrating another embodiment of the invention, the mold being shown in an open position.

FIG. 8 is similar to FIG. 7 but shows the mold in closed position.

FIG. 9 is a sectional view taken along the line 9-9 of FIG. 8.

FIG. 10 is an enlarged and somewhat schematic fragmentary view showing the blocking members and actuator in initial engagement,

FIG. 11 is a similar enlarged view but shows the blocking members and actuator with the shoulders of the enlarged base portion of the actuator fully engaging the blocking members,

FIG. 12 is plan view of an alternative embodiment of the invention wherein four [4] actuators are shown located respectively adjacent corners of a molding apparatus,

FIG. 13 is a somewhat schematic side elevation of an illustrative corner of the FIG. 12 embodiment showing both an actuator and a single co-operating blocking member with associated mold halves in a fully open position, and

FIG. 14 is a side elevation similar to FIG. 13 but with the mold halves in an open position.

### BRIEF DESCRIPTION OF PREFERRED EMBODIMENTS

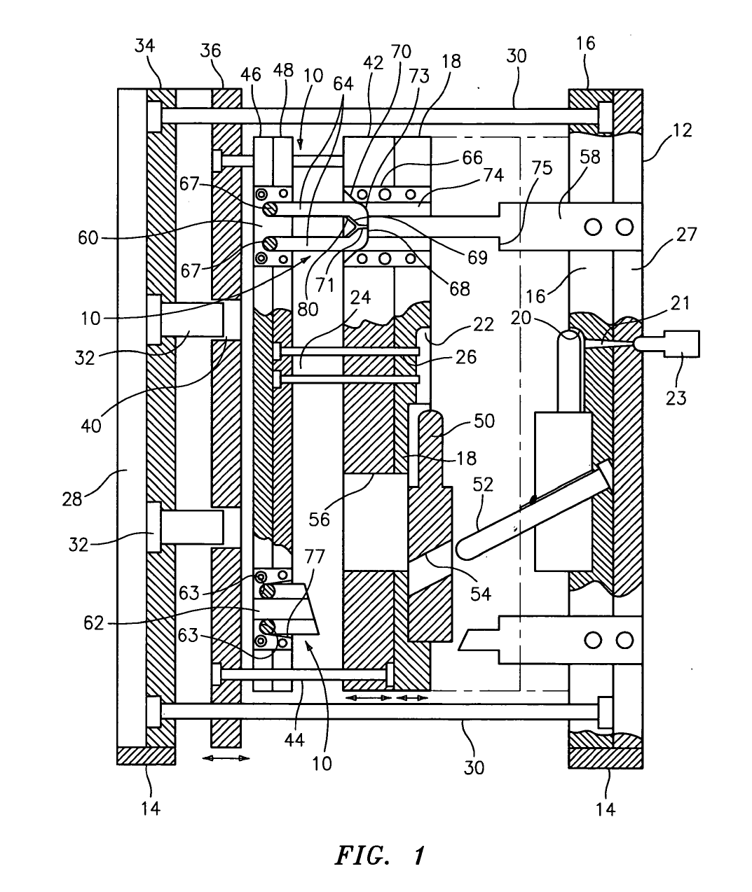

Turning now to the drawings and referring particularly to FIG. 1, an ejector retraction mechanism embodying the present invention and indicated generally by the reference numeral 10 is shown attached to a standard mold base indicated generally at 12 and mounted in an injection molding machine, portions of the machine frame being indicated generally at 14, 14. The mold base 12 carries first and second molds or molds 16 and 18, which respectively define mold cavity sections 20 and 22. The molds are supported for relative reciprocal movement between open and closed positions, mold 16 being stationary and mold 18 moveable toward and away from mold 16. In the open position, shown in full lines in FIG. 1, the mold plates are spaced apart a substantial distance, and in closed position indicated by broken lines, the plates are engaged in face-to-face relationship so that the cavity sections 20 an 22 cooperate to define the mold cavity. Sprue 21 defined by the mold plates 16 and 18 and a part of the mold base 12 communicates with an injection nozzle 23, which comprises a part of the injection-molding machine. A gate, not shown, associated with the mold cavity conducts molten plastic from the nozzle 23 into the cavity. The mold 18 further includes an ejector mechanism, indicated generally at 24, which has one or more ejector pins 26,26 supported for movement into and out of the cavity section 22 when the molds are opening or closing. The ejector retraction mechanism 10 of the present invention functions to positively retract the mold pins 26,26 from the cavity section 22 as the mold plates 16 and 18 move toward the closed position and locks the mechanism 24 in a retracted position while the mold 16 and 18 close and until the molds open to a predetermined position, as will be hereinafter more fully described.

Considering the mold base 12 in further detail, it generally comprises anchor plates 27 and 28 supported in fixed relation to the machine frame 14 and maintained in parallel spaced relationship by tie rods 30, which extend there between. The first mold plate 16 is mounted in fixed position on anchor plate 27 substantially as shown. Anchor plate 28 carries knockout pins 32, 32 which are retained in fixed position by knock out retainer plate 34 mounted adjacent the anchor plate. Mold plate 18 and its associated ejector mechanism 24 are carried by backup plate 36 slidably supported on the tie rods 30, 30. Bore openings 40, 40 formed in the backup plate 36 and respectively aligned with the knock out pins 32, 32 receive the pins therethrough. Mold backup plate 42 carries the second mold plate 18 and is supported in fixed parallel relation to the backup plate 36 by parallel tie rods 44, 44. Ejector pin backup plate 46 and ejector pin retainer plate 48, which comprise the ejector mechanism 24, are also slidably supported on the tie rods 44, 44 for independent movement toward and away from the molds. The plates 46 and 48 carry the ejector pins 26,26 which extend in parallel relationship through the backup plate 42 and the mold 18, and move the pins 26,26 into and out of the mold cavity section 22, as will be hereinafter further described.

The illustrative molding apparatus shown is particularly adapted to form a hollow molded product [not shown] and thus includes a moveable core element 50 slidably mounted on the mold 18 for transverse movement into and out of the mold cavity formed by the cavity sections 20 and 22. Slant pin 52 carried by the plate 16 and 28 cooperates with an inclined bore 54 in the core element 50 to move the core element into and out of the mold cavity in a manner well known in the art. Recess 56 in the plates 18 and 42 receives the slant pin 52 when the molds 16 and 18 move to closed position. Reference may be had to the aforementioned patent to Muttart for further disclosure of a mold base of the aforedescribed general type.

The ejector retraction mechanism 10 may be mounted on a side surface of or embedded in a mold and generally comprises an actuator 58 which may be rectangular or circular in cross section, and which is shown fastened at one end to the stationary mold 16 and the anchor plate 27, and extends toward the anchor plate 28 in the direction of mold movement. A support member 60 mounted in fixed position on backup plate 46 has a channel 62 aligned with the actuator 58 for receiving the free end thereof. A pair of pivoting blocking members or arms 64, 64 are held in arcuate bearing pockets of the support member 60 on opposite sides of the channel 62. Each pivoting arm 64 is secured by a pivot pin 67 and the arms nest against bearing surfaces in arcuate bearing pockets in support member 60 so as to pivot about the axis of the pivot pins, which extend transversely of the direction of mold movement. Thus, the pivot pins handle only a minor portion of the bearing force. Each arm 64 comprises an elongated body with an enlarged head and a blocking surface 68. Opposite cam surfaces indicated respectively at 69 and 70 diverge in the direction of anchor plate 28. Each arm 64 is supported to pivot between a closed position wherein at least a portion of the surface 68 is disposed within the channel 62 and in the path of the actuator 58 and an open position wherein its surface 68 is retracted from the path of the actuator 58. A pair of channel defining members 66, 66 mounted in fixed position on the mold backup plate 42 cooperate to define a further and larger channel 74 and a wedge with opposite inclined surfaces 80, 80 is disposed in the channel. Cam surfaces 69,69 on the of the blocking members 64,64 are engaged by the wedge surfaces 70,70 in a positive movement causing the blocking members 64,64 to spread apart and open.

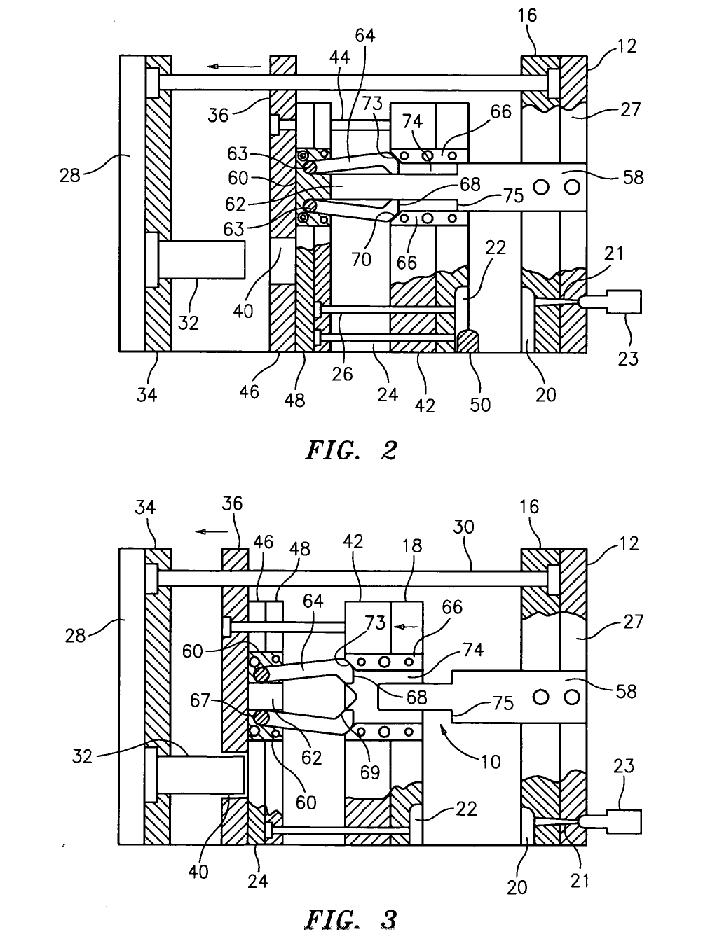

Referring now to FIGS. 2-5, consider the operation of the molding apparatus and, more particularly, the operation of the ejector retraction mechanism 10 during the mold opening cycle when the apparatus is in the position shown in FIG. 2. The first and second mold plates 16 and 18 have begun to separate and the core element 50 urged by the slant pin 52 has begun to retract from the mold cavity section 22. At this point in the machine cycle, the actuator 58 extends into the channel 62 between and beyond the blocking members 64, 64. Each blocking member 64 is maintained in its open position by engagement of its side surface 71 with the side surface of the actuator 58. Cam surfaces 70, 70 engage the blocking member 64, 64 thereby to prevent the blocking members from entering the passageway 62 and moving toward the mold 18. Thus, the blocking members 64, 64 cooperate with the actuator 58 and the cam surfaces 70, 70 to lock the retractor mechanism 24 in its fully retracted position. The plate 46 is now in face-to-face engagement with the backup plate 36, so that the ejector pins 26, 26 cannot enter the cavity section 22 to interfere with the core element 50, which may not yet be fully retracted from the mold cavity section 22.

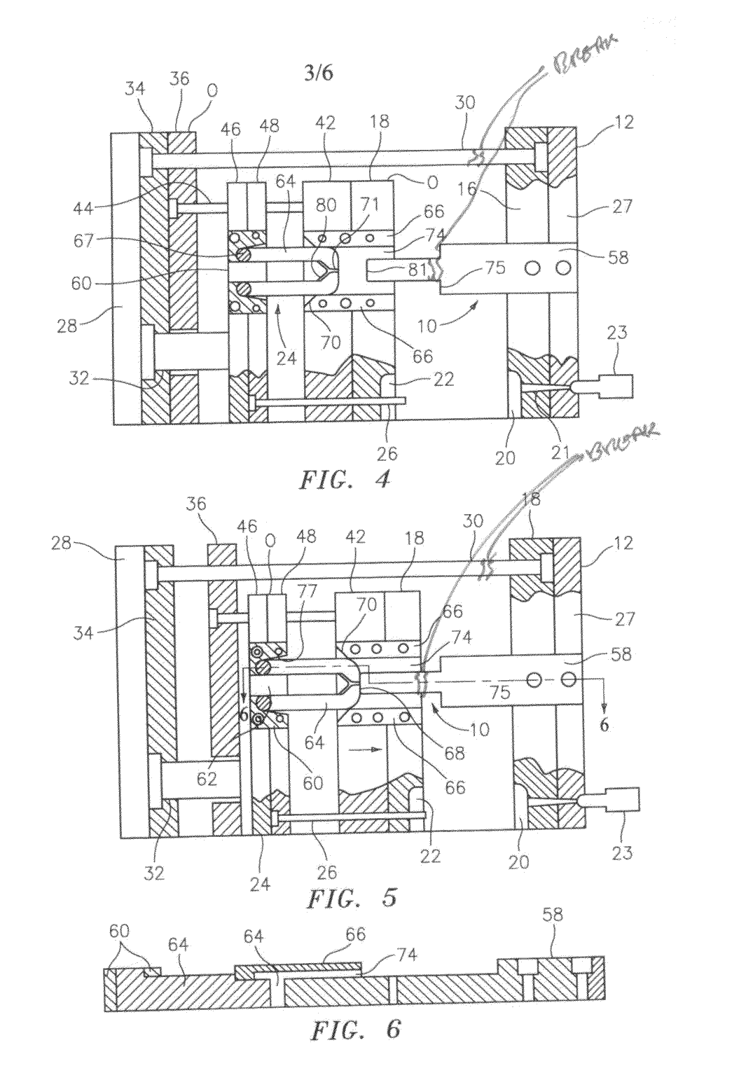

As the mold opening cycle continues, the backup plate 36 continues to move from its position of FIG. 2 in the direction of the anchor plate 28 carrying with it the second mold 18. When the backup plate 36 reaches its position of FIG. 3 the actuator 58 is fully retracted from the channel 62. The core pin 50 is also fully retracted from the mold cavity section 22 to its full line position in FIG. 1. Knock out pins 32, 32 engage the ejector pin support plate 46 to arrest its further movement in the direction of the anchor plate 28. However, the backup plate 36 continues to move in the direction of the anchor plate 28, which causes the blocking members 64, 64 to enter the passageway 74 between the cam members 66, 66. As the blocking members 64, 64 enter the passageway 74 each blocking member 64 engages a cam surface 70 which pivots the blocking member to its closed blocking position [FIG. 4]. Further movement of the mold causes the ejector pins 26 to enter the cavity 22 and positively eject the molded work piece there from. When the backup plate 36 engages the knockout pin retainer plate 34, as shown in FIG. 4, the molds 16 and 18 are in the fully open position.

During the mold closing cycle, backup plate 36 is moved from its position of FIG. 4 in the direction of the mold anchor plate 27 to its position of FIG. 5 by an associated molding machine mechanism [not shown]. Further, during the mold closing cycle, the free end portion of the actuator 58 engages the cam surfaces 68, 68 on the blocking members 64, 64 which are held in closed position by the cam blocks 66, 66 to arrest movement of the pin ejector mechanism 24 in the direction of the anchor plate 27. However, the backup plate 36 and the second mold 18 which it carries continue to move in the direction of the anchor plate which causes relative movement of the pin ejector mechanism away from the mold 18 whereby to retract the ejector pins 26 from the mold cavity section 22.

Upon engagement of the ejector pin support plate 46 with the backup plate 36, as shown in FIG. 2, the ejector pins 26 are fully retracted from the second mold cavity section 22 so that the core element 50 may enter the cavity section 22 without risk of interference with the pins. When the plate 46 is in the FIG. 2 position, the blocking members 64, 64 have been positively moved out of the passageway 74 by the wedge 80 to a position wherein they pivot to their open positions. Thereafter, further movement of the backup plate 36 in the direction of the plate 27 causes the actuator 58 to engage the cam surfaces 68, 68 to pivot the blocking elements 64, 64 to their latching position shown in FIG. 2. In this position, the blocking members 64, 64 cooperate with the actuator 58 and the surfaces 70,70 to retain the ejector mechanism 24 in its fully retracted position with reinforcement by the laterally enlarged actuator base shape 75. During the remainder of travel of the second mold cavity plate 18 to it's fully closed position and until the molds reach a predetermined open position, the core element 50 is substantially inserted into the mold cavity section 22, as previously described.

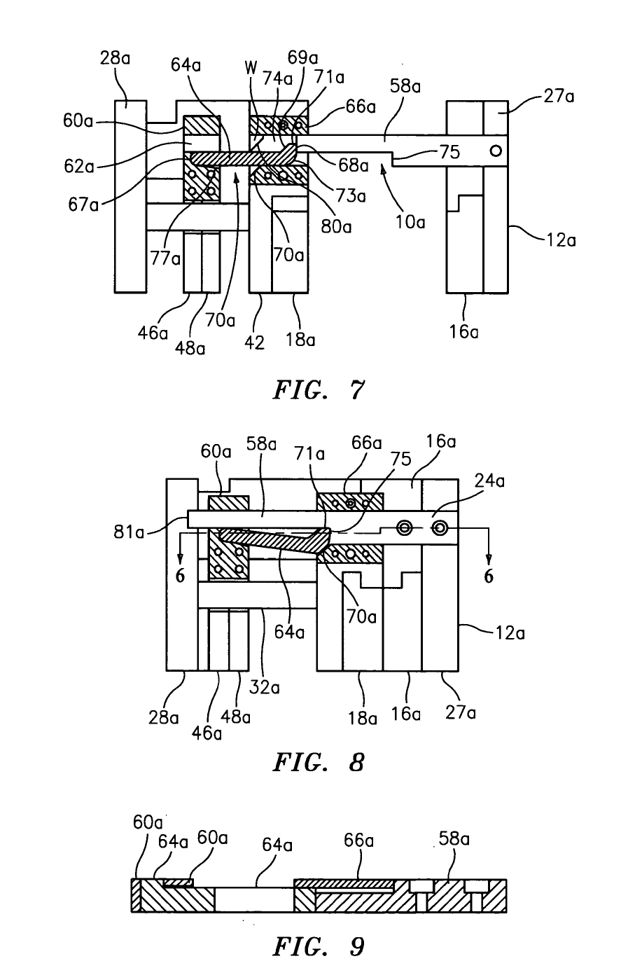

In FIGS. 7 and 8 another ejector retraction mechanism embodying the invention and indicated generally by the reference numeral 10a is shown mounted on a standard mold base indicated generally at 12a. Parts of the illustrated structure, which generally correspond to parts of the previously described embodiment, bear the same reference numerals as the previously described parts with a letter “a” suffix.

The illustrated mold base 12a comprises a model H Master Unit Die marketed by Master Unit Die Products Inc., Greenville, Mich., and has an anchor plate 28a, an anchor plate 27a, and an ejector mechanism indicated generally at 24a, which includes an ejector plate 46a. A first mold 16a carried by the anchor plate 27a, is reciprocally movable toward and away from a second mold 18a supported in fixed spaced relation to the anchor plate 28a. In FIG. 7 the mold base 12a is shown in an open position, whereas in FIG. 8 it is closed, the mold 16a and 18a being in face-to-face relation and defining a mold cavity [not shown]. As in the previously described embodiment, the ejector mechanism 24a is arranged to move generally toward the second mold 18a when the mold base 12a is in an open position.

The illustrated ejector retraction mechanism 10a functions to positively retract the ejector mechanism 24a thereby moving the plates 46a and 48a away from the second mold 18a and from the position in FIG. 7 to the position in FIG. 8 before the molds 16a and 18a reach a predetermined position during closure of the molds. The mechanism 10a generally comprises an elongated actuator 58a secured at one end to the mold base 12a and in fixed relation to the first mold 16a to move therewith. The arm 58a extends in the direction of mold movement and toward the anchor plate 28a. The actuator 58a and the blocking member 64a, pivotally mounted by the support member 60a are arranged to move past each other in sliding engagement when the mold base 12a is moved between its open and closed positions, substantially as shown. A blocking member 64a is received in arcuate bearing surface pocket on the support member 60a and is supported thereon by a pivot pin entering an opening in the wall of the support member 60a and which extends transversely of the support member. The blocking member 64a comprises a generally elongated body which has a bearing radius 67, at its top corner radius 73, top square flat surface 68a, and lateral opposite sides indicated respectively at 69a and 71a which generally diverge in the direction of the anchor plate 28a. The mechanism 10a further includes a block 66a mounted on second mold 18a. A passageway or channel 74a in the block 66a receives the free end of the actuator 58a and the free end of the blocking member 64a of the support member 60a in sliding relation therein substantially as shown. The blocking member 64a is movable relative to the support member 60a between a first position shown in FIG. 7 and a second position shown in FIGS. 8 and 9. In the first position the cam surface 68a is disposed downwardly and then outwardly toward the associated side surface of the support member 60a and into the channel 74a away from the path of the actuating member 58a. In the second position [FIGS. 8 and 9] a portion of the cam surface 70a is disposed outwardly toward the associated side surface of the support member 77 and in the path of relative movement of the support member 60a and the block 66a.

When the mold base 12a is in a substantially fully open position, as it appears in FIG. 7, the ejector mechanism 24a is in its ejecting position relative to the second mold cavity plate 18a so that ejector pins carried by the plates 46a and 48a are disposed within an associated mold cavity section defined by the second mold 18a. When the ejecting mechanism 24a is in its ejecting position the blocking member 64a is maintained in its first position by engagement of the cam surface 70a with a surface of the block 66a. Movement of the clamping plate 27a from its position in FIG. 7 toward its position in FIG. 8 causes the free end of the actuator 58a to engage the cam surface 68a to move the support member 60a end the ejector mechanism 24a to its fully retracted position of FIG. 8. When the blocking members of the support member 60a reaches the position of FIG. 8, the actuating bar 58a acts upon the cam surface 68a and reinforces its locking function which utilizes an enlarged locking surface 75a. At this point, the first mold 16a has moved to a closed position in face-to-face engagement with the second mold cavity plate 18a. During the opening cycle of the molds, the actuator 58a cooperates with the blocking member 64a to retain the ejector mechanism 24a in its retracted position until the molds open to a predetermined position wherein arm 58a allows the blocking member 64a to pivot to its first position.

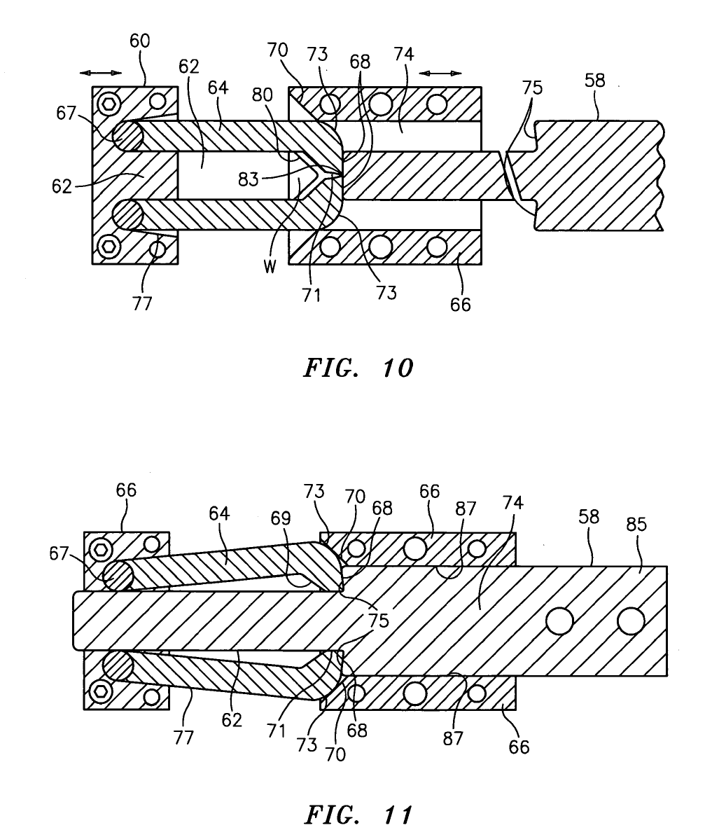

Careful inspection of FIG. 10 and in particular the flat end surfaces 68,68 of the blocking members 64,64 and the inter-engaging flat end surface 83 of the actuator 58 will illustrate an important improvement of the present invention. Parallel flat surface engagement is provided for during the blocking function of the members 64, 64 in contra-distinction with the prior art where line engagement prevails. Over time wear at this extremely narrow and critical area of pressure in the prior art obviously occurs with at least a resulting inaccuracy in the alignment of the end surfaces of the ejection pins and the adjacent wall surfaces of the mold cavity. This of course may result in small circular defects in the surface of molded parts, which may render the parts unacceptable. Moreover, the pins may interfere with the core element 50 and the design of prior art blocking members requiring only a very thin section between the line of engagement and the pivot pins may even result in fracture of the blocking members. In sharp contrast, the pivot pins in the present design are remotely located at the free ends of the blocking members and, additionally, there is little or no stress on the pivot pins, the heavy arcuate bearing surfaces adjacent the end of the pins instead carrying the brunt of the blocking forces.

Referring particularly to FIG. 11 and the enlarged end portion 83 of the actuator 58, the opposite shoulders 75,75 should be noted as well as the rounded outer corners 85,85 thereof. The substantially flat shoulders 75,75 engage and precisely fit the end and opposite corner surfaces 68-73 and 68-73 of the blocking members 64,64 and serve with other associated bearing surfaces to positively lock the members in place.

Further, the rounded corners 85,85 of the shoulders 75,75 facilitate entry of the enlarged portion 83 between opposing walls of the channel 74, which is dimensioned to precisely fit the exterior surfaces 89,89 of the enlarged portion. This aids in the alignment and interlocking of the mold cavities and may even make it possible to eliminate conventional mold interlocks.

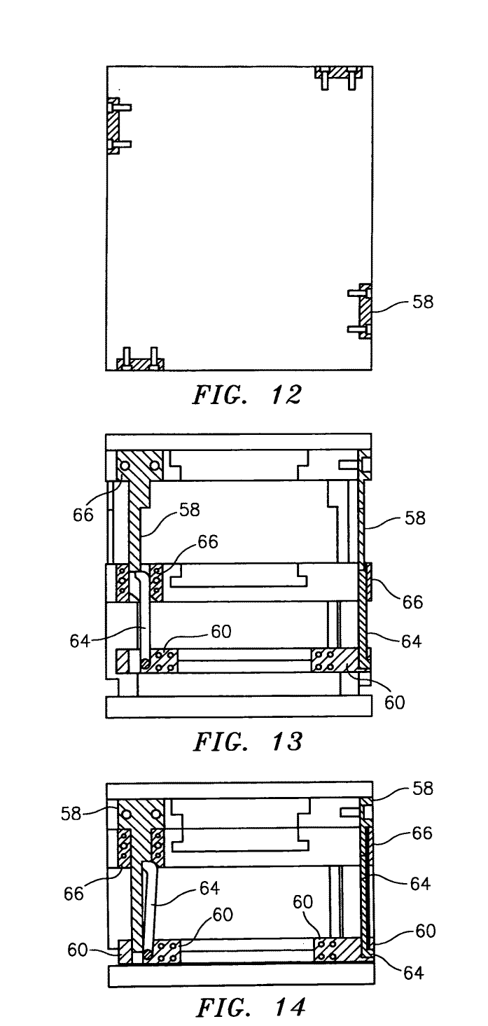

In FIGS. 12 through 14 an alternative embodiment of the invention is illustrated wherein four (4) actuating members 58, 58 have four (4) blocking members 64, 64 operatively associated therewith. The members 58, 58 and the members 64, 64 are in all respects similar to those described above both with regard to construction and operation. With the four assemblies operating in unison precise control over both ejector pin positioning and alignment of the mold halves on both x and y-axes is achieved.

In the light of the foregoing, it will be apparent that substantial improvement has been made in the blocking member and actuator designs of the present invention. Further a new and important function has been introduced to the actuator in the form of the aligning and interlocking feature nowhere found in the prior art.

1. In a molding apparatus having first and second mold plates each with a mold cavity supported in parallel relation for relative reciprocal movement toward and away from each other between open and closed positions relative to each other and cooperating in their closed position to define a mold cavity, an ejector mechanism including ejector pins supported for movement to and retraction from an ejecting position relative to the second mold cavity plate, and an ejector retraction mechanism for retracting said pins before the first and second mold cavity plates move to a closed position, the improvement wherein said ejector retraction mechanism comprises an actuating member mounted in fixed position relative to said first mold cavity plate, a support member mounted in fixed position relative to said ejector pins, at least one blocking member carried by said support member and pivotally movable relative thereto between a first position wherein said one blocking member is in the path of said actuating member and a second position wherein said one blocking member is retracted from the path of said actuating member, and cam means for positively pivoting said one blocking member from its first to its second position and from its second position to its first position in response to movement of said ejector mechanism, said actuating member being engageable with said blocking member in its second position to retract said ejector mechanism from its ejecting position in response to movement of said molds toward closed position, said actuating member and said blocking member having flat parallel surfaces engageable with each other.

2. The combination as set forth in claim 1 wherein said one blocking member has an enlarged head with opposing first and second cam surfaces and is integral with an elongated body, said means for pivoting said member being sequentially engageable with said cam surfaces to pivot said one blocking member from its first to its second position.

3. The combination as set forth in claim 1 wherein said blocking member is supported for pivotal movement about a pivot pin which retains the member in position and by an arcuate bearing seat for an arcuate end surface of the member opposite its head surface.

4. The combination as set forth in claim 1 wherein said means for positively opening said one blocking member comprises a cam surface on a wedge shaped protrusion located in fixed position on the support member.

5. The combination as set forth in claim 4 wherein said blocking and actuating members are located adjacent a side surface of an associated mold plate.

6. The combination as set forth in claim 4 wherein at least one of the members comprising said mounting member and said cam member defines a passageway and said actuating member comprises an elongated bar slidably received in said passageway.

7. The combination as set forth in claim 6 wherein said actuator has a generally rectangular cross section and said passageway has a complementary generally rectangular cross section.

8. The combination as set forth in claim 7 including a pair of pivoting blocking members carried by said support member and wherein said actuating member is movable between said pivoting blocking members when each of said members is in its open position.

9. The combination as set forth in claim 8 wherein said means for pivoting said pivoting blocking members comprises a pair of cam members mounted in fixed position on said ejector plate assembly and cooperating to define a cam member passageway therebetween for receiving said blocking members when said members are moving into said second position, and for maintaining said blocking members in said position while said ejection mechanism is in its ejecting position and until said mechanism is moved from its ejecting position to a retracted position.

10. The combination as set forth in claim 8 wherein said blocking members in their first position maintain said ejector mechanism in its retracted position while said mold plates move to closed position and until said mold plates open to a predetermined position.

11. An ejector retraction mechanism for a molding apparatus having first and second molds movable between open and closed positions and an ejection mechanism movable relative to the one mold between an ejecting position and a retracted position, said ejector retraction mechanism comprising an actuator mounted in fixed position relative to the first mold, a support member mounted in fixed position relative to said ejector mechanism for movement therewith, at least one blocking member carried by said support member and positively pivotally movable relative thereto between both a first position wherein said member is in the path of said actuating arm and a second position wherein said blocking member is retracted from the path of said actuating arm, and at least one cam member mounted on said second mold plate and engaging said blocking member in its second position to pivot said blocking member to its first position in response to movement of said ejector mechanism to its ejecting position.

12. The combination as set forth in claim 11 wherein said support member mounts said blocking member at a free end thereof, said cam member comprises a block defining a passageway receiving said actuating arm in sliding engagement with walls of said passageway thus initiating a positive interlock which is completed when the mold is fully closed.

13. The combination as set forth in claim 12 wherein said ejector retraction mechanism includes a pair of pivoting blocking members and a pair of cam members, each of said blocking members being engageable with one of said cam members, said actuator being movable between and relative to said members when said pivoting blocking members are in said first position.

14. In molding apparatus having first and second molds each with a mold cavity supported in parallel relation for relative reciprocal movement toward and away from each other between open and closed positions relative to each other and cooperating in their closed position to define a mold cavity, an ejector mechanism including ejector pins supported for movement to and retraction from an ejecting position relative to the one mold cavity plate, and an ejector retraction mechanism for retracting said pins before the first and second molds move to a closed position, the improvement wherein said ejector retraction mechanism comprises an actuator mounted in fixed position relative to said one mold, a pair of blocking members operable selectively to block and open a path for movement of said actuator, said actuator having an enlarged base portion with side walls co-operable with the opposing side walls of a fixed channel to precisely align and interlock said mold plates.

15. Molding apparatus as set forth in claim 14 wherein said blocking members have flat end surfaces, and wherein said actuator has a complementary flat parallel end surface for engagement with the flat end surfaces of said members when they are in their blocking position.

16. Molding apparatus as set forth in claim 15 wherein said enlarged base portion of said actuating member defines opposing shoulders with flat surfaces engageable with the aforesaid flat end surfaces of the blocking members to lock said members in position in cooperation with the walls of said fixed channel.

17. Molding apparatus as set forth in claim 1 wherein four (4) assemblies of blocking members and actuators are provided and are mounted respectively adjacent corners of molding apparatus for operation in unison for both x and y axis alignment.
